(19) United States
(12) Patent Application Publication
(10) Pub. No.: US 2006/0191493 A1
(43) Pub. Date: Aug. 31, 2006

(54) WHALE SAFE GROUNDLINE AND YARN AND FIBER THEREFOR

(75) Inventor: Norman L. Holy, Yardley, PA (US)

Correspondence Address: PAUL AND PAUL, 2000 MARKET STREET, SUITE 2900, PHILADELPHIA, PA, 19103, US

(73) Assignee: Better Gear Inc., Yardley, PA (US)

(21) Appl. No.: 11/382,781

(22) Filed: May 11, 2006

Related U.S. Application Data
(63) Continuation-in-part of application No. 11/018,137, filed on Dec. 21, 2004.
(60) Provisional application No. 60/533,069, filed on Dec. 29, 2003.

(51) Int. Cl. A01K 15/04

(52) U.S. Cl. 119/805

(57) ABSTRACT

A whale-safe goundline rope for attachment to undersea traps and seagoing buoys. This rope is made of melt-processable polymers having filler particulate distributed uniformly throughout the polymer, prior to it being extruded into a fiber or yarn. The resultant fiber or yarn includes a plurality of voids or cavities. The manufacturing process generates a hollow rope, with that being a rope made from hollow fibers or yarn or with a hollow twisted core. The rope has a negative buoyancy.

### RELATED APPLICATIONS

This application is a continuation-in-part of pending U.S. application Ser. No. 11/018,137, filed Dec. 21, 2004, which claims priority of U.S. provisional application 60/533,069, filed Dec. 29, 2003 both or which are incorporated herein by reference

### BACKGROUND OF THE INVENTION

The present invention relates to rope, particularly rope used in sea water to secure buoys and lobster and crab traps and the like.

“Groundline” or “mainline” refers to the rope used between traps (also called pots), typically in the lobster, crab, or eel fisheries.

Whales encounter such ropes in the oceans of the world and often die as a consequence of this encounter. The number lost is in the hundreds each year, worldwide. The rope wraps around flippers, the body, the head (especially the rostrum), the tail (fluke) or is caught in the baleen. The danger extends beyond whales to other members of the cetacean family (cetaceans consist of whales, dolphins, and porpoises).

When a whale or other cetacean is entangled in rope, there is a high probability that the animal will die. Death can come from the rope cutting into the animal, all the way through the flesh, with the consequence of the animal bleeding to death. More commonly, the wound becomes infected and the animal dies. Right whales, numbering only 350 in the North Atlantic in 2003, are vulnerable to groundlines since they dive to the depth of the copepods and feed with their mouths open. This type of feeding exposes them to the possibility of taking a rope into their mouths, and the rope catching in their baleen.

Of the eight right whales known to have been entangled, in 2002, in the North Atlantic, only one was freed by rescuers cutting the entangled ropes. The fates of the other seven are unknown, but it's highly likely that many of these whales died. As right whales are on the Endangered Species list, any entanglements have long-term consequences regarding the survivability of the species.

No species of whale is exempt from entanglements in rope. For example, in 2003, some twenty-three humpbacks were entangled in rope in the Gulf of Maine. A significant fraction of these entanglements occurred with groundlines. The National Marine Fisheries Service has attached transmitters to the backs of humpbacks that indicate where the whale is in the water column all the time. It was learned that even humpbacks spend much of their time less than 20 feet from the bottom.

An entangled animal is difficult to find in the vast ocean, and even if rescuers are able to locate the animal it is very difficult to approach close enough to cut the ropes. Even when the animal can be located and approached, the rope may have cut into the animal so far that it cannot be severed. The timeframe from entanglement to death of the whale varies depending on the type of entanglement, but if the rope is wrapped around the rostrum, the whale typically dies in about two months.

Typically, a string or “trawl” of lobster traps consists of 2-20 wire traps connected together by rope going from one trap to another. This rope is commonly made of polypropylene, which has a density of less than that of seawater and thus is buoyant. Fishermen prefer polypropylene groundlines because they handle well have a good grip, and are not very elastic. Because of a density between 0.90-0.92 for polypropylene, polypropylene groundline rope will float upward in a loop in the water that can be 5, 10, 15, or even 30 feet off the bottom. These loops can easily be in the zone where there are whales. Often a whale becomes entangled about the head, or in the baleen, suggesting that the whale was feeding and thus had its mouth open. The magnitude of the danger which groundlines pose to all whales and other cetaceans is illustrated by the fact that there are approximately 10 million lobster traps in the Gulf of Maine, alone. These traps and the accompanying groundlines are in the water for about eight months of the year.

The danger of groundlines to whales comes from the ropes floating up into a column of uprising water into which the cetaceans swim or dive to feed. To get around this problem the National Marine Fisheries Service has encouraged the use of rope with a density greater than that of seawater (1.02 g/cc) to be used as groundline. The theory is that a rope that is at or very close to the bottom will have reduced risk of snaring a whale or other cetacean. Several products are now sold for use as “sinking” or “neutral-buoyant” rope. These are made in one of two ways: (1) a blend of polypropylene and polyethylene monofilaments wrapped with polyester, or (2) pure nylon. These monofilament/fibers are often assembled into “twisted” rope. Typically, monofilaments/fibers are made into yarn. Yarn is twisted into rope.

One problem with the “sinking” and “neutral-buoyant” ropes is that they wear out much faster than floating rope. Wear is rapid regardless of whether the ropes contact sand, mud or hard bottom. On a hard bottom, the wear on the rope is from the outside inward as the rope frays as it moves in the tides and currents. On sand or mud, wear comes mostly from particles becoming embedded within the twists of the rope and then fraying the rope from the inside. A polypropylene (floating) rope might be serviceable for five (5) years. The current sinking ropes last less than one to two years. This much shorter life for a groundline which rests on the bottom is a cost issue for trap fishermen. The current ropes made of polypropylene-polyethylene blend and polyester has the additional characteristic of becoming “frayed” from scrapping on the bottom.

Fishermen do not like frayed groundlines because they are difficult to handle in the haulers, i.e., line hauling equipment. Furthermore, this frayed rope takes up sand and mud and becomes “gritty”, again a characteristic fishermen do not like. Fishermen also do not like sinking groundline constructed of nylon because nylon is too elastic. Ropes made entirely of polyester or of nylon are quite slippery and the fishermen find them difficult to grip.

What is needed is a groundline rope which will sink either to the ocean bottom, or remain very near the ocean bottom as a rope at or very near the bottom of the water column is in an area where whale entanglement is improbable.

Furthermore, what is needed is a groundline rope that handles well and does not incorporate mud or sand, i.e., the rope should not “frizz”.

Additionally, the groundline rope should be less subject to wear than current groundline rope products.

Further, this groundline rope should be highly flexible and be gripped easily by both a fisherman and a hauler.

Moreover, the groundline rope should not be overly elastic, and have the characteristic of elongation-to-break of under 20% elongation.

No extant rope satisfies all these criteria.

### SUMMARY OF THE INVENTION

The object of the present invention is to provide a negative buoyancy rope which has improved wear resistance when resting on the ocean bottom, has good flexibility, does not accumulate grit, does not have elongation-to-break above 20%, and can be gripped readily.

Because fishermen prefer polypropylene ropes, it is the preferred starting polymer. A blend of polypropylene and polyethylene can also be used. To achieve a sinking rope with negative buoyancy, inorganic fillers with higher specific gravity are loaded, i.e., imbedded in the fibers or yarn from which the rope is made. Melt-processable polypropylene blend with filler is extruded into fiber or monofilament. One example, a preferred combination, is 85-70% polypropylene (by weight) and 15-30% (by weight) barium sulfate. The resultant rope will have a feel very much like the current floating rope made of polypropylene, and thus fishermen could accept the rope easily as it can be handled by their equipment similarly to existing groundline rope. The elongation-to-break is under 16%.

The barium sulfate filled polypropylene rope is less subject to wear than a plain polypropylene rope that is held to the bottom with weights. A filled rope is made into a negative buoyancy rope which lies along the bottom and is more resistant to mechanical working from changes in currents, the shifting of sand, and pulling abrasion against rocks.

Useful fillers include talc, silica, barium sulfate, calcium sulfate, clay, diatomatious earth, silica, alumina, kaolin, carbon, aluminum hydroxide, titanium dioxide, glass, wollastonite, organosilicone powders, sand, calcium silicate, and magnesium silicate calcium silicate, iron oxides, aluminum silicate, and mixtures thereof. Barium sulfate is the preferred embodiment because it has a high density (4.2 g/cc), and is readily available in particles under two microns.

### BRIEF DESCRIPTION OF THE DRAWINGS

The features, advantage and operation of the present invention will become readily apparent and further understood from a reading of the following detailed description with the accompanying drawings, in which like numerals refer to like elements, and in which:

FIG. 1 is a block diagram of a three stranded “hawserlaid” type rope of filled polymer material of the present invention;

FIG. 2 is a block diagram of a nine stranded hollow rope of the present invention;

FIG. 3 is a block diagram of equipment and product flow for manufacturing filled polymer fiber and yarn; FIG. 4 is a block diagram of the process steps for making solid and hollow (core) filled polymer rope of the present invention;

FIG. 5 shows a magnified view of a twisted rope made from yarn strands comprising the monofilament fibers of the present invention;

FIG. 6 shows the surface of the barium sulfate-polypropylene mix of the invention at 3,000× magnification;

FIG. 7 shows the surface of the barium sulfate-polypropylene mix of the invention at 10,000× magnification; and

FIG. 8 is a pictorial view of open ocean floating groundline for buoys and traps.

### DETAILED DESCRIPTION OF THE INVENTION

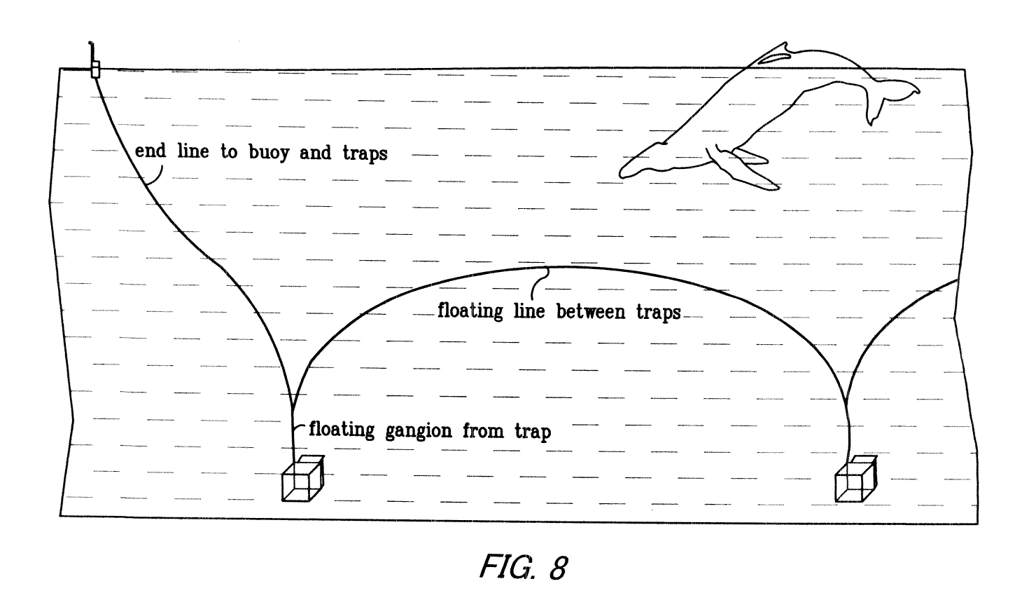

The present invention is an improved rope for use as an open ocean groundline, having a negative buoyancy and enhanced abrasion resistance and resistance to sand infiltration. This rope is intended to reduce or eliminate the floating of groundline which occurs in the open ocean, FIG. 8, and the floating of groundline in water columns frequented by whales and other cetaceans when feeding.

The rope is made from a melt-processed polymer such as a polypropylene or a blend of polypropylene and polyethylene. The polymer is filled with a filler chosen from: talc, barium sulfate, barytes, calcium sulfate, clay, diatomatious earth, silica, alumina, kaolin, carbon, aluminum hydroxide, titanium dioxide, glass, wollastonite, organosilicone powders, sand, calcium silicate, and magnesium silicate calcium silicate, iron oxides, aluminum silicate, and combination mixtures of these.

These filler materials vary considerably in their chemical and physical properties and are not to be considered to give equivalent results. Some are hydrophobic, others anhydrous, others hydrophilic. Adhesion is modest between some fillers and the polymer, and in other cases adhesion is very weak. Polypropylene is the preferred polymer because of the generally low adhesion between filler and polymer.

The specific filler material chosen will also affect the practical range of particle size for the filler. The combination of a particular polymer with a specific filler will not provide identical results as the same polymer with a different filler, or a different polymer with the same filler.

For example, if sodium chloride is finely ground it can be combined with polypropylene to give a sinking rope, but very small particles of sodium chloride, for example, are difficult to extrude when blended with polypropylene because there is a tendency of the particles to bridge in an extruder, even to the point of shutting down the extruder.

The resultant rope product of the present invention has a specific gravity of greater than 1.02 g/cc (grams per cubic centimeter). This product's wear-resistance to abrasion against objects is enhanced. In experimental testing it is reported that after 100 days in the water, a rope made according to the present invention shows only minor damage from abrasion. A new ⅜ diameter polypropylene (PP) rope can break at about 2300±50 pounds. A new ⅜ inch diameter rope made according to the present invention, with 20% BaSO₄ and PP, can break at about 2100±50 pounds, while this rope after wear-in can break at about 1700±50 pounds. This loss of strength is considered to be quite acceptable by the fishermen, and in fact can yield a break strength after wear-in that is approximately equal to or higher than the break strength after wear-in for a 100% PP rope of equivalent initial diameter.

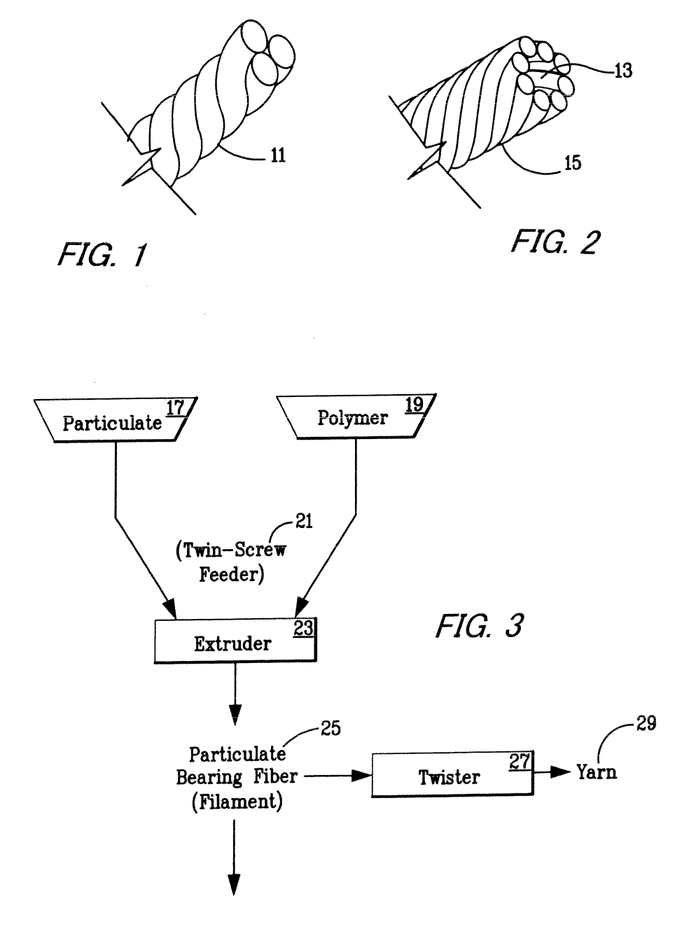

A mixture of filler material and polymer beads is heated and extruded into fiber or yarn from which a twine or strand is twisted. Rope is then braided from the strand material. The rope can be solid as shown in the three strand rope 11 of FIG. 1 or it can been braided around a hollow form to produce a hollow core 13 rope shown in the nine strand rope 15 of FIG. 2.

Both ropes FIGS. 1 and 2 have a negative buoyancy, with specific gravity of greater than 1.02 g/cc. The hollow rope 15 of FIG. 2 will flatten when subjected to lateral forces. In a flattened state the rope 15 will not cut into the flesh or baleen of a whale easily. This will reduce injury upon entanglement or upon collision.

The selected filler particles are loaded into a process feeder bin 17, FIG. 3, while polymer beads are loaded into a feeder bin 19. In order to control the mixture ratio, a twin screw feeder 21 provides a powered draw of raw materials from each bin 17, 19 and force feeds the extruder 23. This feeder 21 also mixes the two ingredients from the bins 17, 19 in a homogeneous dry mix. This mix is fed to an extruder 23, which heats the polymer into a melt and creates a pressure to eject the filled polymer melt from the extruder 23. This is typically accomplished with screw feeds within the extruder itself. Depending upon the selection of commercial equipment the process steps can be carried out by one machine, or by several machines lined-up in a production line.

The fiber strands 25 exiting the extruder 23 are either spooled for storage for later use, or fed into a twisting machine 27, which makes a yarn 29.

The process for manufacturing the groundline rope of the present invention is illustrated in FIG. 4. First, the preferable inorganic filler particles are obtained 31. Then the filler material is sized by screening or other means 33. Out of specification sizes are collected for reprocessing or discarding. The selected size of filler particles are also collected 37. This sizing can be in a range, such as 0.25 to 100 microns, or in a narrower range, such as 15 microns, plus or minus 3 microns. This latter selection equates to 12 to 18 microns selection.

The desired polymer beads are obtained 39 and dry mixed 41 with the filler particles. This dry mixture is then heated and extruded 43 into a fiber or filament which is then spooled 45 for movement to another work station or for movement to storage for curing.

The filaments are twisted into a yarn 47. This twisting 47 occurs at ambient temperatures and at various humidity levels, depending upon the mechanical working required and the polymer material being worked. The yarn is either spooled for storage 49, or sent to a strand twisting station 51 for twisting into a strand.

The strand product is fed to a solid rope braiding station 53 or a hollow rope braiding station 55. An example of the solid rope 11 is shown in FIG. 1. An example of hollow rope 15 is shown in FIG. 2.

A moderate interfacial adhesion is favorable for toughening and ensuring that the particles transfer the stress and stabilizes the cracks at the primary stage of the deformation. This satisfies the stress conditions of plastic deformation for matrix ligaments subsequently via “debonding”. Strong interfacial adhesion is not favorable for toughness because the debonding-cavitation process may be delayed and the plastic deformation of matrix may be inhibited. The incorporation of barium sulfate (BaSO₄) into polypropylene (PP) leads to higher modulus and toughness. The particles act as stress concentrators in the matrix and promote cavitation at the matrix-particle boundary and in turn initiate massive large-scale plastic deformation of matrix.

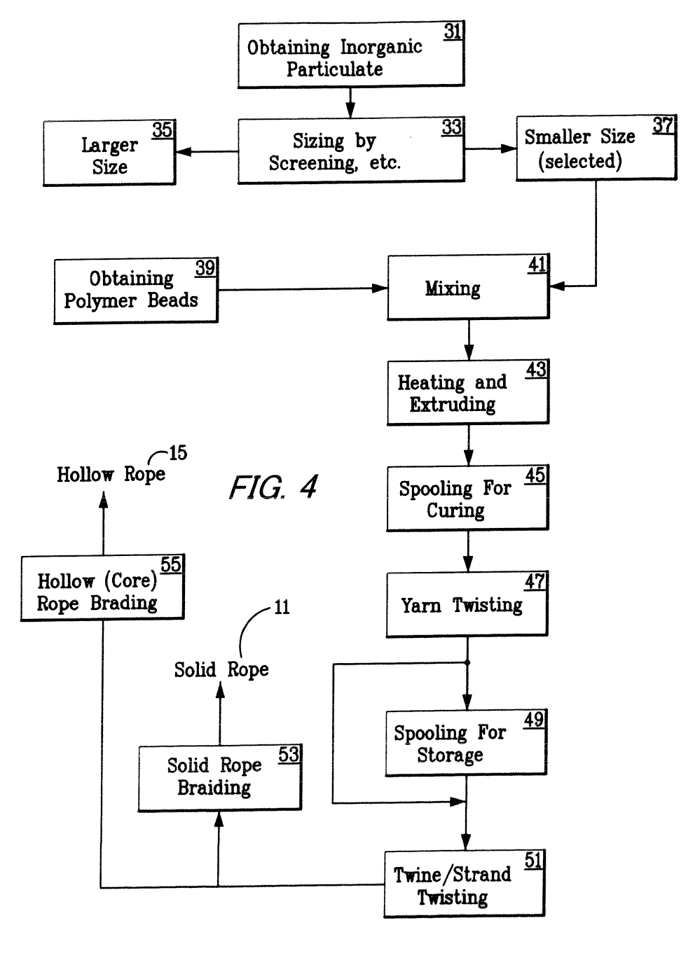

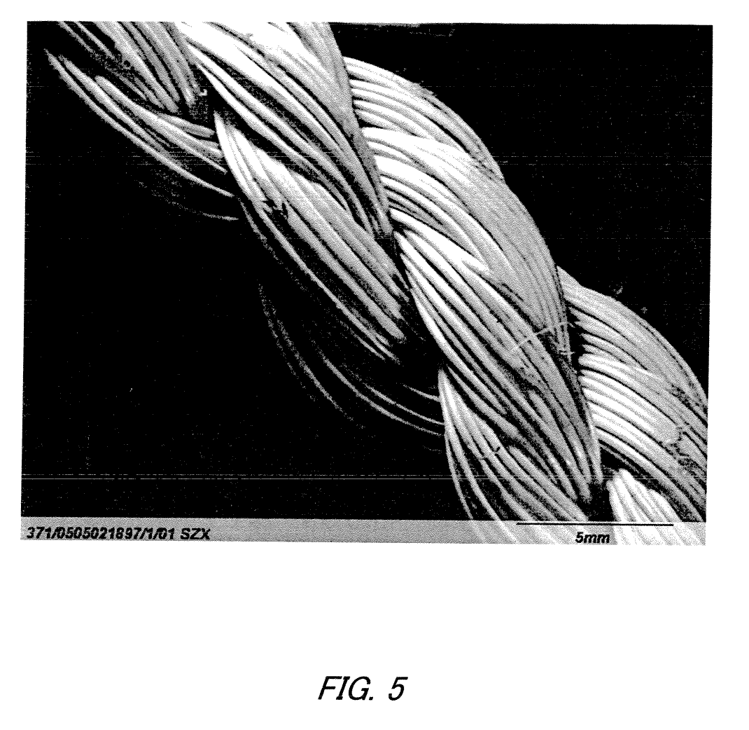

FIG. 5 shows twisted rope 8× magnification with the yarn strands being comprised of monofilament fibers. The monofilament fibers have been twisted into yarn strands. The strands have been twisted into the rope.

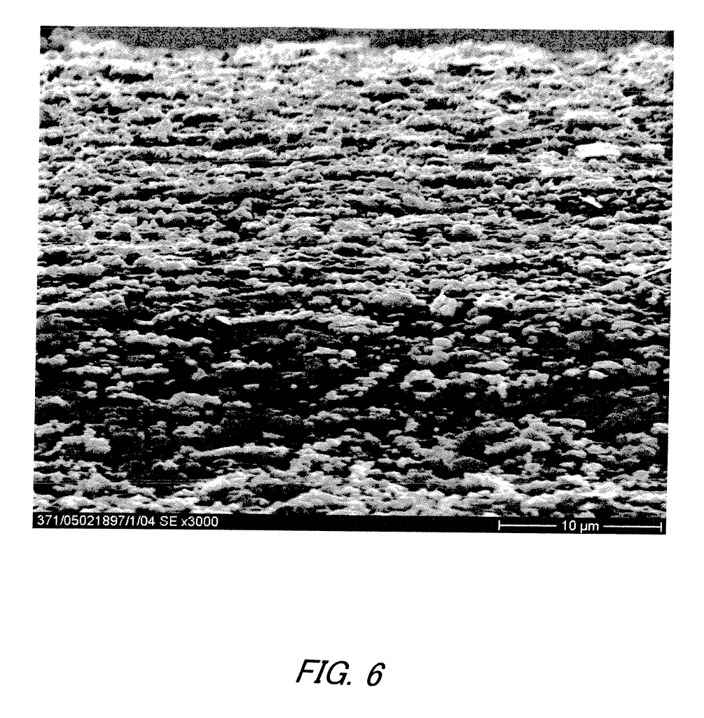

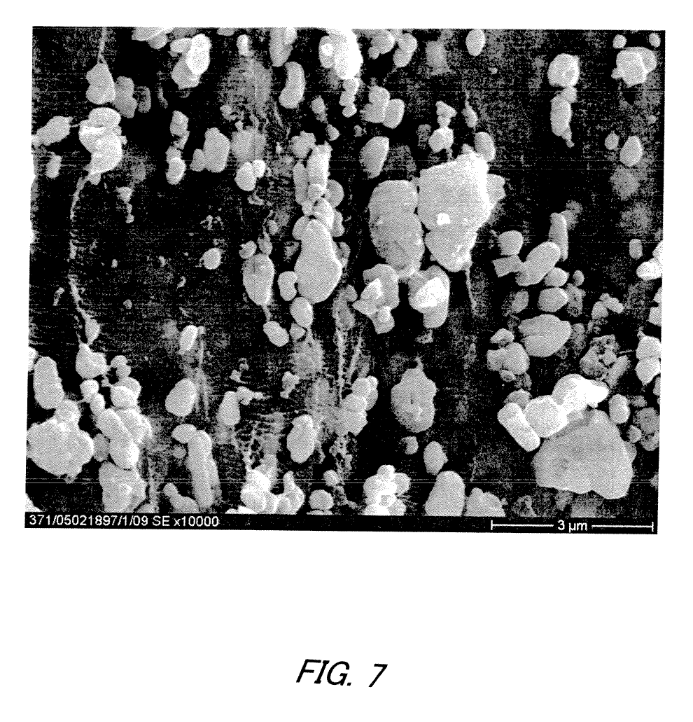

Scanning electron microscope images were made of the surface of a monofilament made according to the present invention. FIG. 6 is a SEM (scanning electron microscope) image of the surface of the filament made at 3,000× magnification. FIG. 7 is a SEM image of the surface of the filament at 10,000× magnification. Both images, FIGS. 6 and 7, show a uniform mixture and a consistent dispersal of the barium sulfate particles which may include spherulites.

FIGS. 6 and 7 show the surface of the monofilament that is cluttered with particles of barium sulfate. This reflects a situation in which there is poor adhesion between polypropylene and barium sulfate. The particles are in effect rejected from the polymer matrix. This poor adhesion between particle and polymer also leads to cavities or hollow spaces around the particles that remain suspended within the polymer matrix.

The presence of the barium sulfate on the surface of the polypropylene provides an enhanced wear resistance to the polypropylene.

The formation of cavities results in a lower density of material than would be predicted, assuming close contact between BaSO₄ and the PP (polypropylene). For example, a groundline (rope) with 20% by weight of barium sulfate and 80% polypropylene would have a theoretical density of about 1.08 g/cm³, based on simply summing weight percentages and density. However, the actual resultant rope can have a density in the range of slightly above 1.02g/cm³ to about 1.04 g/cm³, being affected by mix and draw speeds and particle sizing. This is about a 4% reduction from the anticipated density, and can possibly be about a 6% reduction. Thus, the poor bonding between the particles and polymer lowers the density of the composite and introduces the presence of cavities or void spaces. The lower density of the composite translates into rope (or fiber or yarn) that has unexpectedly excellent flexibility.

When polypropylene is derivatized with 1% (by weight) maleic anhydride, a polymer is formed that forms smaller and fewer voids. A composite of 80% (by weight) PP-Maleic anhydride and 20% barium sulfate has a density of 1.08 g/cm³ when extruded, and formed into rope. This product is much stiffer than the rope made of polypropylene plus barium sulfate alone.

When a ⅜ inch diameter rope of the maleic anhydride derivatized polymer was coiled into a “natural” circle, i.e., a circle formed without any compression placed upon the rope, the ⅜ inch diameter rope coiled into a circle with a diameter of 11.5 inches. This compares to a ⅜ inch diameter rope composed of only polypropylene and barium sulfate, which when coiled formed a circle of 7.5 inches.

Thus, the presences of cavities or voids is a condition that leads to a flexible rope. Previously, there has been no observation of there being any correlation between cavity content and the flexibility of a monofilament, a fiber, a yarn, or a rope. In the case of the present invention, a rope with good flexibility is the key to acceptance by fishermen.

Table 1 shows a comparison of percentage elongation to tensile forces applied, between polypropylene rope and the polypropylene-barium sulfate rope of the present invention.

TABLE 1
Elongation to break of polypropylene ropes of
starting diameter of 0.375 inches:

| Rope | Initial Break (lbs.) | Elongation to Break (%) |
|---|---|---|
| Polypropylene 100% | 2230 | 18 |
| Polypropylene- | 2100 | 11 |
| 20% BaSO4 | | |
| Polypropylene | 1110 | 8 |
| BaSO4 50% | | |

Table 2 shows a comparison between polypropylene rope and the polypropylene-barium sulfate rope of the present invention after 500 cycles of a wear test, showing the change in the diameter of the rope size and the change in break strength after wear testing. The wear test was designed to simulate the type of wear conditions a rope is subjected to with haulers (on boat hauling equipment). This includes tensile forces, abrasion and twisting.

A test length of rope was tied to the crank arm of a gear motor which produced a reciprocating motion on the rope. The rope passed over a first pulley and then was twisted on itself and then passed over a second pulley. Thereafter it passed over a third pulley tied to a tension weight. The first and third pulleys were positioned at the same level and the second pulley placed below them to form an isosceles triangle which the rope follows as it is twisted or wrapped on itself and unwrapped. The vertex angle at the end of the wrap increases as the twisted section gets longer. Each pulley is pinned to a fixed position.

TABLE 2
Size and break strength change of polypropylene ropes of
starting diameter 0.375 inches.

| | Initial | | Final | Final |
|---|---|---|---|---|
| Rope | Break (lbs) | Cycles | Diameter (in) | Break (lbs |
| Polypropylene | 2230 | 500 | 0.268 | 1160 |
| 100% | | | | |
| Polypropylene- | 2100 | 500 | 0.302 | 1420 |
| 20% BaSO4 | | | | |
| Polypropylene- | 1110 | 500 | 0.352 | 925 |
| 50% BaSO4 | | | | |

Table 1 shows that as the percentage of filler (BaSO₄) is increased the breaking strength of the rope decreases and the percent elongation at break decreases. This provides a desirable result regarding whale-safe groundlines.

Table 2 shows that at the percentage of filler (BaSO₄) is increased the wear reduction in diameter is reduced and the percentage loss in break strength due to wear is also reduced.

The rope of the present invention breaks earlier (under less force for its size) and does not thin down. The chances of cutting into a whale baleen is therefore lessened.

The invention provides a fisheries rope to the fisherman of a size and feel familiar to him and with coiling and hauling characteristics compatible with his equipment. The initial breaking strength, wear resistance, elongation to break, and breaking strength with wear is adjustable with the mixture from which the fiber/monofilament is drawn and from which the resultant yarn and rope is made.

The present invention groundline and yarn and fiber therefor, which reduces the elongation of the resultant blended rope (or yarn or fiber/monofilament), increases wear resistance and reduces diameter wear-loss.

Many changes can be made in the above-described invention without departing from the intent and scope thereof. It is therefore intended that the above description be read in the illustrative sense and not in the limiting sense. Substitutions and changes can be made while still being with the scope of the appended claims.

What is claimed is:

1. A monofilament fiber suitable for twisting into yarn wherein said yarn is suitable for twisting into rope, comprising:
a melt-processable polymer; and
filler particles distributed uniformly in said polymer;
wherein said filler occupies between about 10% to about 50% by weight of the fiber; said filler having an average particle size in the range of about 0.25 microns to about 100 microns; and
wherein the addition of said filler to the polymer contributes to the formation of voids in said polymer.

2. The fiber of claim 1, wherein said filler partially migrates to the surface of said fiber.

3. The fiber of claim 2, wherein there is bonding between said filler particles and said polymer.

4. The fiber of claim 3, also including a debonding agent in said polymer.

5. The fiber of claim 3, also including a silicon coupling agent in said polymer.

6. The fiber of claim 3, also including a bonding agent in said polymer.

7. The fiber of claim 4, wherein said debonding agent is stearic acid.

8. The fiber of claim 5, wherein said silicon coupling agent is silane.

9. The fiber of claim 6, wherein said bonding agent is maleic anhydride.

10. The fiber of claim 2, wherein said voids reduce the density of said fiber by at least about 4%.

11. The fiber of claim 2, also including silane in said polymer, wherein said spherulite cluster formation is reduced.

12. The fiber of claim 2, wherein said polymer is polypropylene.

13. The fiber of claim 2, wherein said filler is barium sulfate and wherein said surface of polypropylene has a plurality of barium sulfate particles.

14. The fiber of claim 2, wherein said filler selected from the group of: talc, silica, barytes, calcium sulfate, clay, diatomatious earth, silica, alumina, kaolin, carbon, aluminum hydroxide, titanium dioxide, glass, wollastonite, organosilicone powders, sand, calcium silicate, and magnesium silicate calcium silicate, iron oxides, aluminum silicate, and combination mixtures of these.

15. The fiber of claim 2, wherein said polymer is selected from the group of polyethylene and nylon and combination mixtures of these.

16. The fiber of claim 13, wherein said surface particles enhance the wear resistance of said fiber.

17. The fiber of claim 14, wherein said filler enhances the resistance of said fiber to abrasion wear.

18. The fiber of claim 1, wherein said partial size of said filler is uniform to about plus or minus 15%, whereof said fiber has increased wear resistance to surface friction by at least about 10% compared with a like polymer fiber without said filler.

19. The fiber of claim 1, wherein the average particle size of said filler is in the range of about 0.25 to about 20 microns.

20. The fiber of claim 1 wherein said filler is distributed in said fiber in an amount of about 15% to about 30% on a weight basis.

21. A method of making a monofilament fiber, suitable for twisting into yarn wherein said yarn is suitable for twisting into a rope, having increased wear-resistance, comprising the steps of:
(a) making a uniform blend of at least about 10% by weight of:
a filler having a particle size in the range of about 0.25 microns to about 100 microns, and
a melt-processable polymer selected from the group consisting of polyethylene, polypropylene, nylon, and a blend of these; and
(b) extruding said uniform blend into a fiber having a density greater than 1.02 g/cc, wherein the wear-resistance is increased by at least about 10% compared with a fiber or yarn made from said like melt-processable polymer without said filler, and wherein voids are created which reduce the density of the extruded fiber.

22. The method of claim 21, wherein said filler is of inorganic material.

23. The method of claim 22 wherein said extruding step produces a hollow fiber.

24. A method of making a rope having increased wear-resistance, comprising the steps of:
(a) making monofilament fibers according to the method of claim 21; and
(b) fabricating said rope from said fibers.

25. A method of making a rope having increased wear-resistance, comprising the steps of:
(a) making a yarn of plural monofilament fibers according to the method of claim 21; and
(b) fabricating said rope from said yarn.

26. The method of making rope of claim 25, wherein said fabricating step includes braiding said fiber or yarn into a hollow rope, having a hollow core or center.

27. The method of making rope of claim 26, wherein said fabricating step includes braiding said fiber or yarn into a hollow rope, having a hollow core or center.

28. A whale-safe polymer blend rope for use with fishing gear, comprising:
a rope containing a polymer mixed with filler materials, said rope having increased wear resistance and reduced elongation properties; and
wherein said rope is made of monofilament fibers being the product of claim 2.

29. A whale-safe polymer blend rope for use with fishing gear, comprising:
a rope containing a polymer mixed with filler materials, said rope having a reduction in diameter loss due to use and wear; and
wherein said rope is made of monofilament fibers being the product of claim 2.
